(19) United States
(12) Patent Application Publication
(10) Pub. No.: US 2003/0146720 A1
(43) Pub. Date: Aug. 7, 2003

(54) Control arm with two parallel branches

(76) Inventors: Alain Riwan, L'hay Les Rojes (FR); Florian Gosselin, Fontenay Aux Roses (FR)

Correspondence Address: Pearne Gordon, McCoy & Granger, Suite 1200, 526 Superior Avenue East, Cleveland, OH, 44114-1484, US

(21) Appl. No.: 10/296,893

(22) PCT Filed: Jun. 20, 2001
(86) PCT No.: PCT/FR01/01927

(30) Foreign Application Priority Data
Jun. 21, 2000 (FR) 00/07930

(51) Int. Cl. H02P 1/00

(52) U.S. Cl. 318/1

(57) ABSTRACT

The master arm comprises two parallel branches (1, 2), preferably symmetric, joining together at a control wrist (7). The branches are formed of segments (3, 4, 5, 6), the first (3) of which extend from a common base (8), and moving away from the base such that the branches move apart from each other and prevent the appearance of kinetic singularities.

The purpose of this invention is a control arm comprising two branches in parallel.

The function of control arms is to transfer movements applied to them by an operator as control instructions for an instrument or a system, usually a remote robot called a slave arm or a computer simulation. When the control arm has a sufficient number of degrees of freedom, the operator can control it in translation and in rotation in space.

The arms used in robotics have a very wide variety of shapes. The most traditional arms are composed of a sequence of segments connected to each other by articulations or sometimes by other types of joints; this arrangement is said to be “in series”. But there are disadvantages with these arms as soon as the number of segments becomes large. Thus, mechanisms located at joints have clearances which accumulate by producing a significant imprecision on the position of the free end of the arm. Furthermore, the motors that normally have to be added to the arm to control the conditions of the joints in order to modify their configuration, or on the other hand to keep them fixed regardless of the external forces applied to them, and that are often the heaviest part of the arms, create excessive bending moments that may make it necessary to reinforce the segments structure and therefore to further increase the weight of the arm, making it inconvenient to handle. It has been suggested that the motors should be transferred to the fixed base on which the arm is installed, but this solution requires transmissions between the motors and the joints that they control, which is not always possible and makes the arm complex.

This is why constructions using several (two or more) branches in parallel have been considered more recently in the history of robotics, and in which the distal ends are connected together. For the same number of degrees of freedom, the branches of the arms made in this manner are not as complex as in robots in series, which considerably attenuates the disadvantages of the lack of precision in the position of the arm and the weight of the branches. However, there are specific limitations with this type of robot. It may be difficult to make a simple control to bring them into a required state, due to their greater kinetic complexity; their working range is usually smaller than that of arms in series, since it is limited by the working range of the different branches in parallel and by collisions between segments of the different branches; finally, a defect correlated to the previous defect is that the number of singularities, which are configurations that must be avoided since the robot may be affected by uncontrolled movements, is usually greater.

Singularities correspond to local disappearances of degrees of freedom, or uncontrolled movements. Uncontrolled movement singularities are specific to parallel robots, but all singularities restrict the usage range of the arm. This disadvantage is more pronounced with master arms, which are not designed to apply repetitive movements or movements known in advance and that are controlled by hand, without thinking about singularities, and that may therefore be reached by improvisation. This is why they have to be limited, by transferring them to the ends of the working range.

The most similar document according to prior art is perhaps an article by Iwata entitled “Pen-based haptic virtual environment” (IEEE-ICRA, 1993, p. 287 to 292) that describes a parallel robot with two branches connected together by a wrist, but in which the branches are arranged side by side. This arm comprises singularities due to a degree of freedom of screwing in the wrist and risks of collision between the branches.

It can be concluded from these various comments that arms in parallel are attractive as master arms due to the convenience in handling them, but their specific defects actually make many of them unsuitable for this application. The invention relates to a particular arrangement of arms in parallel, in which the main advantages are a large reduction in the number of collisions between the different bodies of the robot and singularities. The result is ease of control, so that the movement required to reach the required state can be imposed on them without difficulty.

These objectives are achieved with an arm with branches in parallel and with a special configuration; in its most general form, the invention relates to a robot arm composed of articulated segments distributed into two branches connected by a wrist, and the branches are made so as to extend from a common base in two halves on opposite sides of a separation plane when the said plane intersects the wrist, and they comprise corresponding segments connected to the base that extend in opposite directions from the base. Advantageously, the number of segments is the same in each branch; they can still be similar and symmetric if the segments switched to the base are colinear with each other. In all cases, the branches are well separated from each other for almost all movements applied to the wrist, which almost completely eliminates collisions between the branches.

In one preferred form of the invention, the branches comprise three first segments connected to each other and to the base by articulations with a force feedback motor, and a wrist connector segment.

In some variant embodiments, the arm may be fitted with a wrist holder with a constant orientation.

The invention will be described in more detail with reference to the following figures:

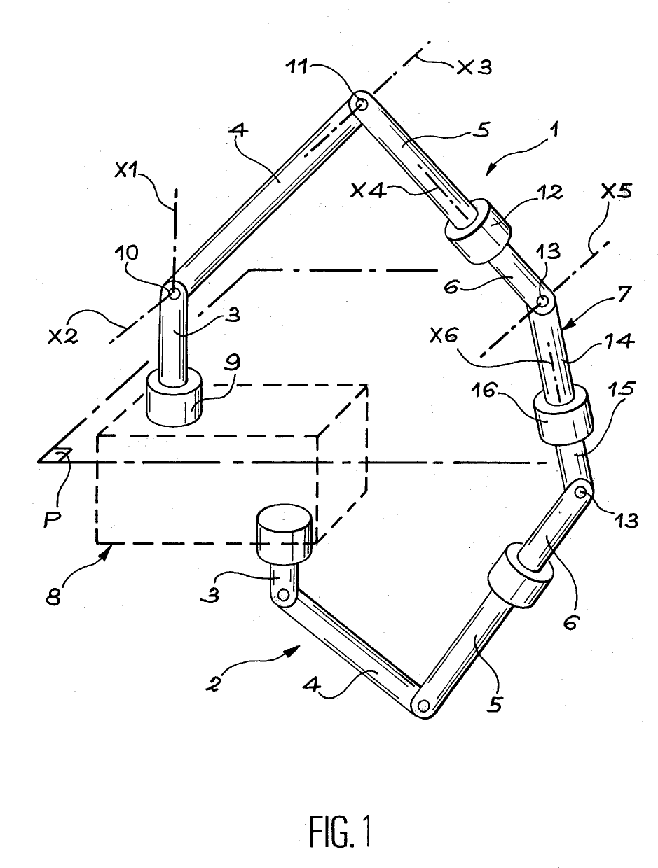

FIG. 1 is a diagrammatic view of the invention;

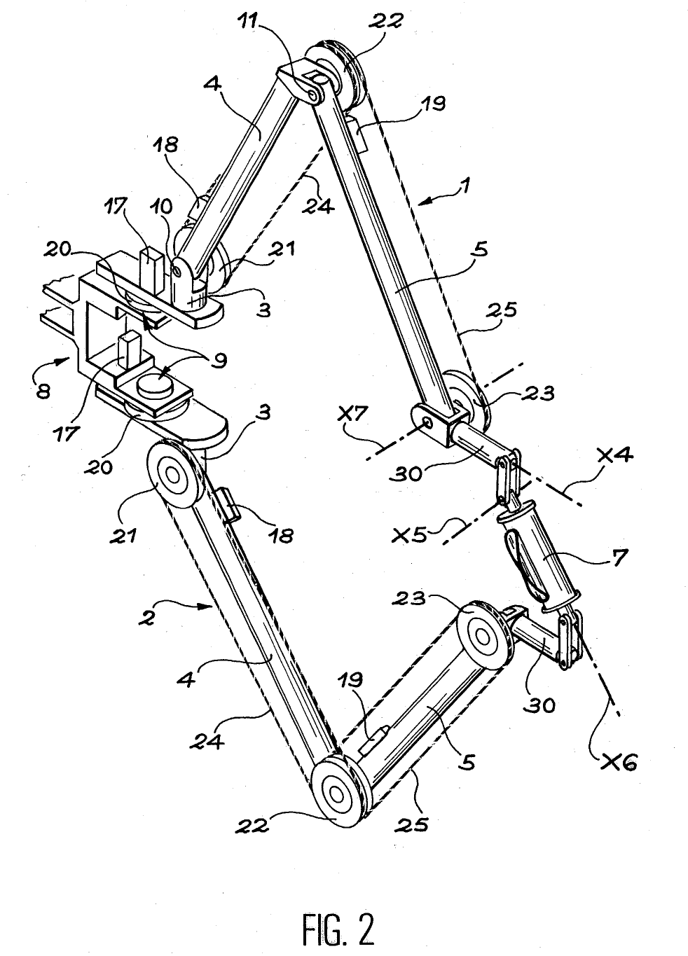

FIG. 2 is a view of an improved embodiment;

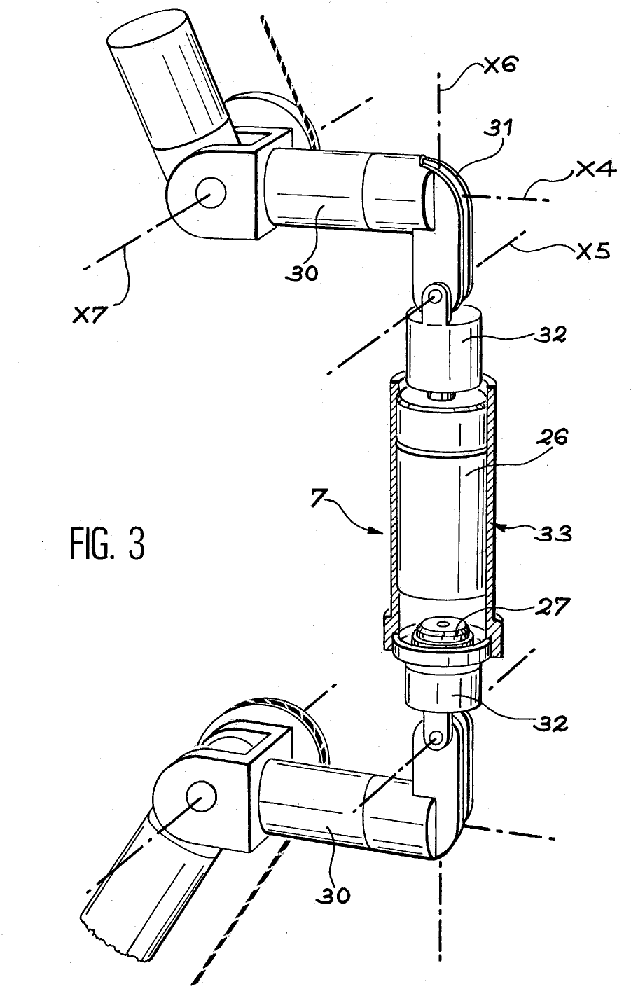

and FIG. 3 is a view of an improved wrist.

With reference to FIG. 1, it can be seen that the arm is composed.of an upper branch 1 and a lower branch 2, each of which is composed of a first vertical segment 3 (the said segments 3 extending in opposite directions from a common base 8), a second segment 4, a third segment 5, a fourth segment 6, and a wrist 7 connecting the ends of the two fourth segments 6 together. The articulations successively connect the segments to each other and to the wrist, and to the common base 8 as follows: a pivoting articulation with axis X1 in line with the first segment 3 and marked with reference 9 connects the first segment 3 to the common base 8; a rotary articulation with axis X2 perpendicular to the previous axis connects the first segment 3 and the second segment 4; another rotary articulation 11 with axis X3 parallel to the previous axis connects the second segment 4 to the third segment 5; a pivoting articulation 12 with axis X4 colinear with the third segment 5 and the fourth segment 6 connects them together and the axis X4 is perpendicular to the two previous axes; finally, a pivoting articulation 13 with axis X5 perpendicular to the previous axis connects the fourth segment 6 to the wrist 7. The wrist 7 is itself composed of two colinear parts 14 and 15 that are connected together by a pivoting articulation 16 with axis X6 that is colinear with them and perpendicular to the previous axis X5 and that can rotate with respect to parts 14 and 15. The two branches 1 and 2 are as symmetric as possible, in other words it is recommended that they should have the same number of segments arranged in the same manner and with equal lengths. However, the first segments 3 of branches 1 and 2 may have different lengths, with no major disadvantage. The common base is usually small, which means that the articulations 9 are close together and that the branches move apart before they converge towards the articulation 16. The arrangement of the branches is not symmetrical due to their large number of degrees of freedom and the irregular movements applied to them.

In the part of the description above, as in other parts of this description, position indications such as “vertical”, “upper”, etc., are not limitative since the arm can be placed in any orientation whatsoever. The “pivoting” articulations make the segment that follows them rotate about its extension axis, whereas “rotary” articulations make it rotate about another axis so as to modify the angle between segments connected by them.

A movement applied by the operator holding the wrist 7 moves the two branches 1 and 2, essentially by using articulations 9, 10 and 11 to control translation movements of the wrist 7, and the other articulations 12, 13 and 16 to control its rotation movements. The good decoupling observed between these two groups of articulations is sufficient to facilitate control and to reduce singularities, which are often the result of too many couplings between the articulations of the arm. Another advantage specific to the invention is the reduction in the number of collisions, which is due to the distribution of branches 1 and 2 in different portions of space; one of the first three segments 3 is fixed to the top of the common base 8 and the other is fixed to its bottom, in other words they extend along opposite directions, such that the second segments 4, the third segments 5, etc., are moved away from each other. The branches 1 and 2 are entirely arranged in opposite halves of space separated by a median plane P, provided that it passes through the wrist 7. When the wrist is raised or lowered, the branches are moved towards each other, but the distance between them is sufficient to prevent any collisions except in extreme positions or for extreme orientations.

The first segments 3 may be offset laterally, as is shown here; but it is more advantageous for them to be in line with each other, and that the distance between the articulations 10 should be identical to the distance between the articulations 13; finally, it is advantageous that the lengths of segments 4 should be equal, and also that the lengths of segments 5 and 6 combined should be equal. In general, the objectives of the invention are achieved better if branches 1 and 2 are symmetrical and similar.

FIG. 2 shows an improved embodiment. Branches 1 and 2 comprise a first short segment 3 followed by a second segment 4 which is fairly long and a third segment 5 which is equally long. The articulations 9, 10 and 11 are identical to the previous embodiment.

The equal lengths of the second and third segments 4 and 5 attached to the much shorter length of the other elements of the arm make its shape almost a perfect diamond, which is excellent to give a wide range of displacements free of collisions.

The arm in FIG. 2 is innovative in that it comprises a wrist holder 30 between the third segment 5 and the corresponding end of the wrist 7. The distal end of the third segment 5 is articulated to the wrist holder 30 through an articulation axis X7, which will advantageously be made parallel to axes X2 and X3. The wrist holders 30 comprise ends 31 that rotate about an axis X4, coincident with a general direction of elongation of the wrist holders 30; end pieces 32 are fixed to the ends 31 with the ability to rotate about them about the X5 axes perpendicular to X4 axes, and a handle 33 connects the end pieces 32 to each other, keeping them colinear with each other, while being free to rotate about an axis X6 coaxial with them. Advantageously, this axis is orthogonal to the pairs of axes X4 and X5 described above in a reference configuration. The handle 33 pivots about axis X6 without changing the distance between the X4 axes or the wrist holders 30, which avoids the risk of creating any collisions by bringing the branches close to each other.

The X4, X5 and X6 axes are degrees of freedom identical to the previous degrees of freedom, in that they are formed by pivoting articulations for X4 and X6, and rotation articulations for X5. The axis X7 is formed by a pivoting articulation but it is not a real degree of freedom as will be explained.

An essential element to be considered is that the wrist holders 30 and their axes X4 form a constant angle with fixed planes, in this case horizontal planes, which limits the risk of introducing singularities. This is created using a transmission comprising a support pulley 21 coaxial with axis X2 and fixed to the first segment 3, a return pulley 22 coaxial with the axis X3 and that can turn freely on segments 4 and 5, a support pulley 23 coaxial with axis X7 and fixed to the wrist holder 30 and two belts 24 and 25 tensioned respectively between pulleys 21 and 22, and 22 and 23, thus forming a chain, for each branch 1 and 2. Regardless of the movement applied to segments 4 and 5, the action of the belts 24 and 25 holds the axis X7 in a direction identical to the vertical plane that they form, since the pulley 21 remains fixed.

The wrist holders 30 kept at a constant orientation increase decoupling between rotation movements and translation movements for the wrist assembly 7.

We will now describe the arm actuation mode. Motors are used to feedback forces felt at the slave arm or generated by a computer simulation, to the operator. These motors 17 are arranged on the fixed base 8 and assist in rotating the first segments about the axis X1 using a gear, a belt or another transmission, motors 18 are placed on the X2 axes and are used to rotate the second segments 4 with respect to the first segments 3, other motors 19 are placed on the X3 axes and are used to adjust the angles between the second and the third segments 4 and 5. The motors can also be placed on the X2 axes; their movement is then transmitted to the X3 axes using a pulley or other type of transmission, and particularly a connecting rod transmission, corresponding to a parallelogram type assembly well known to those skilled in the art. There is no need to place the motor on the X7 axes which are controlled otherwise, nor on X4 and X5 axes since the rotations about these two axes are a result solely of movements at the ends of the third segments 5; but a motor 26 for force feedback to the handle 33 may be added so as to control the degree of freedom for pivoting about the X6 axis. Advantageously, the motor 26 can be fixed to a duct forming the handle 33 installed on one of the end pieces 32 free to rotate by means of a bearing 27, while the output shaft from motor 26 is connected to the opposite end piece 32. It may also be installed elsewhere, on the base 8 or on one of the branches 1 or 2, which however necessitates a transmission device to the handle 33.

Sensors such as angular position encoders are associated with the different motors to measure their movements and to indicate the state of the arm and the imposed controls, but these techniques are also known in this case and will not be described in this text. If a degree of freedom is superfluous, the pivoting control of the handle 33 which is the most difficult to produce precisely and comfortably, may be eliminated.

The device at the end of the arm is not necessarily a handle, but it may also be a pen, a ball, a clamp, etc., depending on the envisaged applications, for example games, simulation devices, remote handling, remote operation or remote displacement for various industries.

1. Robot arm composed of articulated segments distributed into two branches (1, 2) connected by a wrist (7) at their corresponding ends, free to move in translation and in rotation, characterized in that the branches are made so as to extend, starting from a common base (8), in two halves of space on opposite sides of a separation plane (P) when the wrist (7) is intersected by the said plane, and comprise correspondent segments (3, 4, 5, 6) connected to the base that extend from the base in opposite directions moving away from each other.

2. Robot arm according to claim 1, characterized in that the segments of the branches that are connected to the base are connected through pivoting articulations (9), the said segments (3) connected to the base thus being held in invariable directions.

3. Robot arm according to claim 2, characterized in that the segments connected to the base are colinear.

4. Robot arm according to any one of claims 1 to 3, characterized in that the branches comprise at least three segments (3, 4, 5).

5. Robot arm according to any one of claims 1 to 4, characterized in that it comprises wrist holders (30) connecting the branches to the wrist and held at a constant orientation by transmissions (21 to 25).

6. Robot arm according to any one of claims 1 to 5, characterized in that the wrist (7) comprises a pivoting handle (33) with a force feedback motor (26).

7. Robot arm according to any one of claims 1 to 6, characterized in that the branch segments are connected to each other and to the base by articulations with a force feedback motor.
